(19) United States
(12) Patent Application Publication
(10) Pub. No.: US 2023/0395927 A1
(43) Pub. Date: Dec. 7, 2023

(54) POWER STORAGE DEVICE

(71) Applicant: TOYOTA JIDOSHA KABUSHIKI KAISHA, Toyota-shi (JP)

(72) Inventor: Yoshiro KAMO, Ashigarakami-gun (JP)

(73) Assignee: TOYOTA JIDOSHA KABUSHIKI KAISHA, Toyota-shi (JP)

(21) Appl. No.: 18/130,578

(22) Filed: Apr. 4, 2023

(30) Foreign Application Priority Data
Jun. 2, 2022 (JP) 2022-090264

(51) Int. Cl. H01M 50/289; H01M 10/658; H01M 50/211

(52) U.S. Cl. CPC H01M 50/289; H01M 10/658; H01M 50/211

(57) ABSTRACT

A power storage device includes: a power storage stack including a plurality of power storage modules arranged in a first direction; a pair of restraint plates sandwiching the power storage stack in the first direction; a pair of side wall portions opposite to each other in a second direction orthogonal to the first direction, with the power storage stack located in between; and a plurality of stoppers located outside each of opposite sides of the power storage stack in the second direction and arranged between the power storage stack and each side wall portion. On an outer main surface of each restraint plate, a plurality of reinforcing portions arranged in a third direction orthogonal to the first and second directions are disposed, and each stopper is disposed at a position overlapping, in the first direction, a corresponding reinforcing portion of the plurality of reinforcing portions.

### CROSS REFERENCE TO RELATED APPLICATIONS

This nonprovisional application is based on Japanese Patent Application No. 2022-090264 filed on Jun. 2, 2022 with the Japan Patent Office, the entire contents of which are hereby incorporated by reference.

### BACKGROUND

### Field

The present disclosure relates to a power storage device mounted on a vehicle.

### Description of the Background Art

Conventionally, as a power storage device used in a mobile phone, a notebook personal computer, a video camera, or the like, Japanese Patent Application Laid-Open No. 2008-235170 discloses a structure in which an assembled battery (power storage stack) made of a lithium ion secondary battery is housed in a case, a side surface between the assembled battery and the case is partially covered with an elastic body, and a foaming filler is disposed at a corner portion of the side surface.

### SUMMARY

When a power storage device is mounted on a vehicle, even when an impact is transmitted to the power storage device due to a collision such as a side collision, the assembled battery (power storage stack) accommodated in the case is required to be hardly damaged.

When the structure of Japanese Patent Application Laid-Open No. 2008-235170 is applied to a power storage device mounted on a vehicle, the vibration resistance can be improved by disposing an elastic body and a foaming filler in a part between the housing case and the assembled battery. However, when the impact is transmitted to the storage case, if the storage case is pushed inward in the portion filled with the foaming filler, the foaming filler pushed into the storage case may push the assembled battery. In this case, the assembled battery may be damaged.

The present disclosure has been made in view of the aforementioned problem, and an object of the present disclosure is to provide a power storage device capable of suppressing breakage of a power storage stack when an impact is input from the outside.

A power storage device based on the present disclosure includes: a power storage stack including a plurality of power storage modules arranged in a first direction; a pair of restraint plates that sandwich the power storage stack in between in the first direction; a pair of side wall portions that are opposite to each other in a second direction orthogonal to the first direction, with the power storage stack located between the side wall portions; and a plurality of stoppers located outside each of opposite sides of the power storage stack in the second direction and arranged between the power storage stack and each side wall portion of the pair of side wall portions. Each restraint plate of the pair of restraint plates has an outer main surface located opposite to a side where the power storage stack is located. On the outer main surface of each restraint plate of the pair of restraint plates, a plurality of reinforcing portions are disposed that each extend in the second direction and are arranged in a third direction orthogonal to the first direction and the second direction. Each of the plurality of stoppers is disposed at a position overlapping, in the first direction, a corresponding reinforcing portion of the plurality of reinforcing portions, at each of opposite ends, in the second direction, of the corresponding reinforcing portion.

In the above-described configuration, the portions of the restraint plate that are provided with respective reinforcing portions have a higher rigidity and are less likely to deform when an impact is applied in the second direction. Therefore, the stopper is disposed at a position overlapping, in the first direction, a corresponding reinforcing portion of the plurality of reinforcing portions, and therefore, when an impact is applied in the second direction, it is possible to prevent the stoppers disposed between the power storage stack and the corresponding side wall portion of the pair of side wall portions from directly pushing inward the power storage stack. Thus, breakage of the power storage device can be suppressed.

In the power storage device based on the present disclosure as described above, the power storage stack may include: a cooler disposed between power storage modules adjacent to each other; a first current collecting plate stacked on one side, in the first direction, of one endmost power storage module in the first direction; and a second current collecting plate stacked on another side, in the first direction, of another endmost power storage module in the first direction. In this case, preferably each of the plurality of stoppers is disposed in contact with the plurality of power storage modules and not in contact with the cooler, the first current collecting plate, and the second current collecting plate.

In the above-described configuration, the cooler, the first current collecting plate, and the second current collecting plate having respective electric potentials are not in contact with the stopper, so that short circuit of the power storage stack can be suppressed.

In the power storage device based on the present disclosure as described above, each of the plurality of stoppers has an inner surface facing the power storage stack.

In this case, a heat insulating member may be disposed on the inner surface.

In the above-described configuration, the heat insulating member is provided so that condensation on the inner surface of the stopper can be suppressed.

In the power storage device based on the present disclosure as described above, opposite ends, in the third direction, of each of the stoppers may be located inside respective opposite ends, in the third direction, of the corresponding reinforcing portion, as seen in the first direction.

In the above-described configuration, the sidewall portions restrain the stoppers from being pushed inward, when an impact is applied in the second direction. Thus, it is possible to further prevent the stoppers disposed between the power storage stack and the side wall portions from directly pushing inward the power storage stack from.

In the power storage device based on the present disclosure as described above, each of the plurality of reinforcing portions includes: a pair of flange portions that are disposed on the outer main surface, extend in the second direction, and are spaced from each other in the third direction; a pair of standing wall portions that extend upright from respective inner ends, in the third direction, of the pair of flange portions; and a connecting wall portion that connects the standing wall portions of the pair of standing wall portions.

In the above-described configuration, even when the restraint plate extends over a greater range, the restraint plate can be reinforced with the simple features, which thereby enable reduction of the manufacture cost.

In the power storage device based on the present disclosure as described above, each of the plurality of stoppers may be fastened to a corresponding reinforcing portion of the plurality of reinforcing portions.

In the above-described configuration, the stoppers can be positioned easily to overlap, in the first direction, respective reinforcing portions.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view of a power storage device according to a first embodiment.

FIG. 2 is a cross-sectional view taken along the line II-II shown in FIG. 1.

FIG. 3 is a cross-sectional view taken along the line III-III shown in FIG. 1.

FIG. 4 is a plan view showing a positional relationship between a reinforcing portion and a stopper in the power storage device according to the first embodiment.

FIG. 5 is a plan view showing a positional relationship between a reinforcing portion and a stopper in the power storage device according to the second embodiment.

FIG. 6 is a plan view showing a positional relationship between a reinforcing portion and a stopper in the power storage device according to the third embodiment.

### DESCRIPTION OF THE PREFERRED EMBODIMENTS

Hereinafter, embodiments of the present disclosure will be described in detail with reference to the drawings. In the following embodiments, the same or common portions are denoted by the same reference numerals, and description thereof will not be repeated.

### Embodiment 1

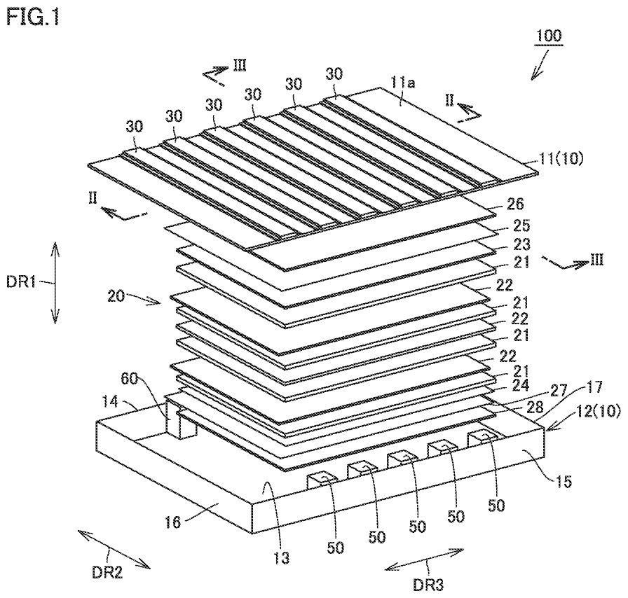

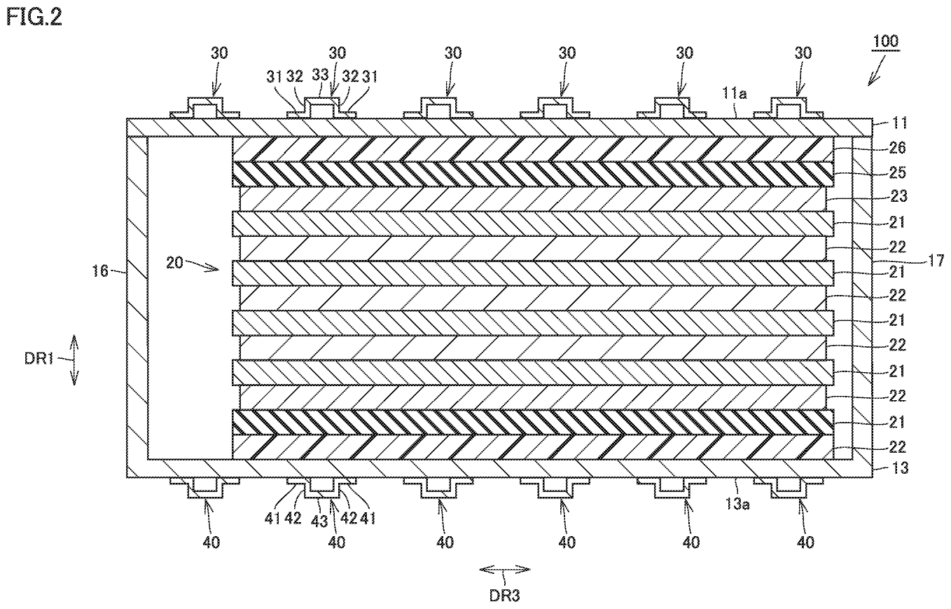

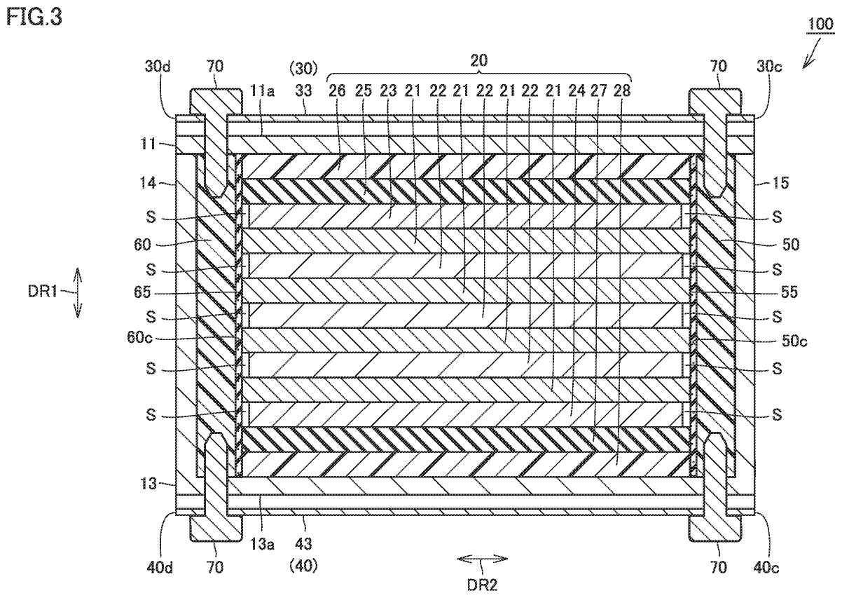

FIG. 1 is an exploded perspective view of a power storage device according to a first embodiment. FIG. 2 is a cross-sectional view taken along the line II-II shown in FIG. 1. FIG. 3 is a cross-sectional view taken along the line III-III shown in FIG. 1. A power storage device 100 according to a first embodiment will be described with reference to FIGS. 1 to 3.

The power storage device 100 is mounted on a vehicle such as a hybrid vehicle that can travel by using power of at least one of a motor and an engine, or an electric vehicle that travels by a driving force obtained by electric energy.

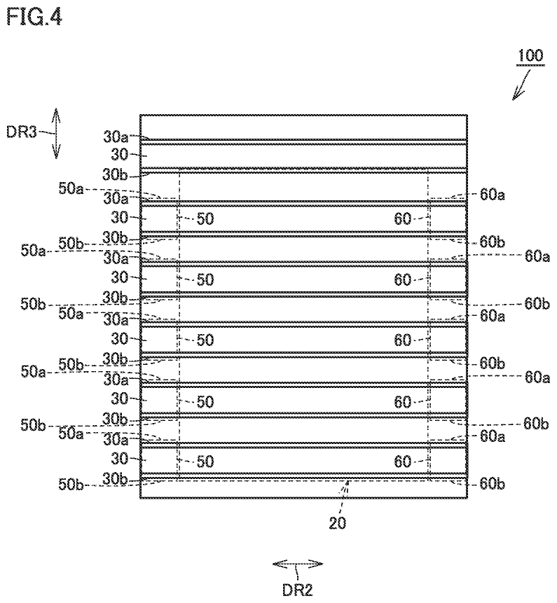

The power storage device 100 includes a housing case 10, a power storage stack 20, and a plurality of stoppers 50 and 60 (see FIG. 4).

The power storage stack 20 includes a plurality of power storage modules 21, a plurality of coolers 22, a first current collecting plate 23 and a second current collecting plate 24, insulating sheets 25 and 27, and elastic sheets 26 and 28.

The plurality of power storage modules 21 are arranged in the first direction (DR1 direction). The first direction is parallel to the vertical direction of the vehicle when the power storage device 100 is mounted on the vehicle.

The plurality of power storage modules 21 are, for example, so-called bipolar batteries. More specifically, the power storage module 21 is a laminate type aqueous battery, and is a secondary battery such as a lithium ion battery. The power storage module 21 is not limited to the above, and may be configured by an all-solid battery, a capacitor, or the like.

The plurality of coolers 22 are disposed between the power storage modules 21 adjacent to each other. The plurality of coolers 22 are provided with refrigerant flow paths through which the refrigerant can flow. The cooler 22 cools the power storage module 21.

The first current collecting plate 23 is laminated on one side in the first direction of the power storage module 21 positioned on the closest side in the first direction. The first current collecting plate 23 is, for example, a positive electrode current collector plate. The first current collecting plate 23 is connected to a positive terminal (not shown).

The second current collecting plate 24 is laminated on the other side in the first direction of the power storage module 21 located on the other side in the first direction. The second current collecting plate 24 is, for example, a negative current collector. The second current collecting plate 24 is connected to a negative terminal (not shown). Charge and discharge of the power storage stack 20 are performed using the negative terminal and the positive terminal.

An insulating sheet 25 is disposed on one side of the first current collecting plate 23 in the first direction. An elastic sheet 26 is disposed on one side of the insulating sheet 25 in the first direction.

An insulating sheet 27 is disposed on the other side of the second current collecting plate 24 in the first direction. An elastic sheet 28 is disposed on the other side of the insulating sheet 27 in the first direction.

The housing case 10 houses therein the power storage stack 20 and the plurality of stoppers 50 and 60. The housing case 10 includes a restraint plate 11 forming a ceiling portion and a lower case 12.

The restraint plate 11 has a plate shape extending over a wide range. For example, the length of the restraint plate 11 in the second direction (DR2 direction) orthogonal to the first direction may be approximately 1210 mm, and the length of the restraint plate 11 in the third direction (DR3 direction) orthogonal to the first direction and the second direction may be approximately 1535 mm.

The second direction is parallel to the lateral direction of the vehicle in the mounted state. The third direction is parallel to the longitudinal direction of the vehicle in the mounted state.

The restraint plate 11 may be made of, for example, a metal member such as SUS. The restraint plate 11 is fastened and fixed to side wall portions 16 and 17 of a lower case 12, which will be described later, using fastening members such as bolts.

The restraint plate 11 has an outer main surface 11a positioned on the side opposite to the side where the power storage stack 20 is positioned. A plurality of reinforcing portions 30 are provided on the outer main surface 11a.

Each of the plurality of reinforcing portions 30 is provided so as to extend along the second direction. The reinforcing portions 30 extend from one end of the restraint plate 11 in the second direction to the other end of the restraint plate 11 in the second direction. The reinforcing portions 30 are arranged side by side in the third direction. The plurality of reinforcing portions 30 may be welded to the restraint plate 11 by welding or the like, or may be fixed to the restraint plate 11 by a fastening member. The plurality of reinforcing portions 30 may be formed of a metal member such as SUS.

The reinforcing portion 30 includes a pair of flange portions 31, a pair of standing wall portions 32, and a connecting wall portion 33. The pair of flange portions 31 is disposed on the outer main surface 11a. The pair of flange portions 31 extend in the second direction and are arranged at intervals in the third direction.

The pair of standing wall portions 32 stand from the inner end portions of the pair of flange portions 31 in the third direction. The connecting wall portion 33 connects the pair of standing wall portions 32.

The lower case 12 has a substantially box shape opened toward one side in the first direction. The lower case 12 may be made of, for example, a metal member such as SUS. The lower case 12 includes a restraint plate 13 as a bottom portion and a plurality of side wall portions 14 to 17.

Similarly to the restraint plate 11, the restraint plate 13 has a plate shape extending over a wide range. The restraint plate 13 faces the restraint plate 11 in the first direction. The power storage stack 20 is constrained by sandwiching the power storage stack 20 by the restraint plate 11 and the restraint plate 13.

The restraint plate 13 has an outer main surface 3a positioned on the side opposite to the side where the power storage stack 20 is positioned. A plurality of reinforcing portions 40 are provided on the outer main surface 13a.

Each of the plurality of reinforcing portions 40 is provided so as to extend along the second direction. The reinforcing portions 30 extend from one end of the restraint plate 13 in the second direction to the other end of the restraint plate 13 in the second direction. The reinforcing portions 40 are arranged side by side in the third direction. The plurality of reinforcing portions 40 may be welded to the restraint plate 13 by welding or the like, or may be fixed to the restraint plate 11 by a fastening member. The plurality of reinforcing portions 40 may be formed of a metal member such as SUS.

The plurality of reinforcing portions 40 are provided at positions corresponding to the plurality of reinforcing portions 30. Specifically, the plurality of reinforcing portions 40 are provided at positions opposed to the plurality of reinforcing portions 30 in the first direction.

The reinforcing portion 40 has substantially the same shape as the reinforcing portion 30. The reinforcing portion 40 includes a pair of flange portions 41, a pair of standing wall portions 42, and a connecting wall portion 43. The pair of flange portions 41 is disposed on the outer main surface 13a. The pair of flange portions 41 extend in the second direction and are arranged at intervals in the third direction.

The pair of standing wall portions 42 stand from the inner end portions of the pair of flange portions 41 in the third direction. The connecting wall portion 43 connects the pair of standing wall portions 42.

Since the reinforcing portions 30 and 40 have the above-described shape, the restraint plates 11 and 13 can be reinforced with a simple configuration even when the restraint plates 11 and 13 are in a wide range as described above, and the manufacturing cost can be suppressed.

The plurality of side wall portions 14 to 17 are provided at the peripheral edge of the restraint plate 13. The plurality of side wall portions 14 to 17 are connected to the peripheral edge of the restraint plate 13. The pair of side wall portions 14 and 15 are opposed to each other in the second direction. The pair of side wall portions 14 and 15 extend along the third direction.

The pair of side wall portions 16 and 17 are opposed to each other in the third direction. The pair of side wall portions 16 and 17 extend along the second direction. The side wall portion 16 connects the end portions of the pair of side wall portions 14 and 15 positioned on one side (front side) in the third direction. The side wall portion 17 connects the end portions of the pair of side wall portions 14 and 15 positioned on the other side (rear side) in the third direction.

FIG. 4 is a plan view showing a positional relationship between a reinforcing portion and a stopper in the power storage device according to the first embodiment. The details of the stoppers 50 and 60 will be described with reference to FIGS. 3 and 4.

As shown in FIGS. 3 and 4, the plurality of stoppers 50 and 60 are disposed on both outer sides of the power storage stack 20 in the second direction.

Specifically, the plurality of stoppers 60 are disposed between the power storage stack 20 and the side wall portion 14 on one side in the second direction. The plurality of stoppers 60 are arranged side by side at intervals in the third direction.

The plurality of stoppers 60 are disposed at positions overlapping the corresponding reinforcing portions 30 and 40 in the first direction on the side of the first end portions 30c and 40c in the second direction of the corresponding reinforcing portions of the plurality of reinforcing portions 30 and 40. Each of the plurality of stoppers 60 is disposed between the first end portion 30c of the corresponding reinforcing portion 30 in the second direction and the first end portion 40c of the corresponding reinforcing portion 40 in the second direction.

Each of the plurality of stoppers 60 is fixed to the corresponding reinforcing portion 30, 40 by, for example, a fastening member 70. More specifically, the stopper 60 is fastened and fixed to the reinforcing portions 30 and 40 by the fastening member 70 penetrating the reinforcing portion 30 in the first direction and the fastening member 70 penetrating the reinforcing portion 40 in the first direction. This makes it possible to easily position the stopper 60 so as to overlap the reinforcing portions 30 and 40 in the first direction.

The manner in which the plurality of stoppers 60 are fixed is not limited to fastening and fixing, and may be appropriately selected such as adhesion and welding.

Each of the plurality of stoppers 60 has an inner surface 60c facing toward the power storage stack 20. A heat insulating member 65 is provided on the inner surface 60c. Thus, even when the stopper 60 is cooled, the occurrence of dew condensation on the power storage stack 20 side can be suppressed.

The plurality of stoppers 50 are disposed at positions overlapping the corresponding reinforcing portions 30 and 40 in the first direction on the second end portions 30d and 40d side in the second direction of the corresponding reinforcing portions among the plurality of reinforcing portions 30 and 40. Each of the plurality of stoppers 50 is disposed between the second end portion 30d of the corresponding reinforcing portion 30 in the second direction and the second end portion 40d of the corresponding reinforcing portion 40 in the second direction. The second end portions 30d and 40d are located on the opposite side of the first end portions 30c and 40c in the second direction.

Each of the plurality of stoppers 50 is fixed to the corresponding reinforcing portion 30,40 by, for example, a fastening member 70. More specifically, the stopper 50 is fastened and fixed to the reinforcing portions 30 and 40 by the fastening member 70 penetrating the reinforcing portion 30 in the first direction and the fastening member 70 penetrating the reinforcing portion 40 in the first direction. This makes it possible to easily position the stopper 50 so as to overlap the reinforcing portions 30 and 40 in the first direction.

The manner in which the plurality of stoppers 50 arc fixed is not limited to fastening and fixing, and may be appropriately selected such as adhesion and welding.

Each of the plurality of stoppers 50 has an inner surface 50c facing the power storage stack 20. A heat insulating member 55 is provided on the inner surface 50c. Thus, even when the stopper 50 is cooled, the occurrence of dew condensation on the power storage stack 20 side can be suppressed.

The plurality of stoppers 50 and 60 extend along the third direction. The plurality of stoppers 50 and 60 are provided in contact with the plurality of power storage modules 21 and not in contact with the cooler 22, the first current collecting plate 23, and the second current collecting plate 24. Specifically, the cooler 22, the first current collecting plate 23, and the second current collecting plate 24 are disposed on the inner side of the power storage module 21 in the second direction, thereby providing a gap S between the plurality of stoppers 50 and 60 and the cooler 22, the first current collecting plate 23, and the second current collecting plate 24. As a result, short-circuiting of the cooler 22, the first current collecting plate 23, and the second current collecting plate 24 having potential can be suppressed through the plurality of stoppers 50 and 60.

The plurality of stoppers 50 and 60 preferably have an insulating property. Further, the plurality of stoppers 50 and 60 may be made of a resin member having a substantial rigidity so as not to move with respect to vibration. The resin member has dimensional stability, and it is easy to design a plurality of stoppers 50 and 60.

Further, in a plan view (when the power storage device 100 is viewed from the first direction), both ends 50a and 50b of each of the plurality of stoppers 50 in the third direction and both ends 60a and 60b of each of the plurality of stoppers 60 in the third direction may be positioned outside both ends 30a and 30b of the corresponding reinforcing portion 30 in the third direction.

As described above, in the power storage device 100 according to the first embodiment, each of the plurality of stoppers is disposed at a position overlapping the corresponding reinforcing portions 30 and 40 in the first direction on both end portions of the corresponding reinforcing portions 30 and 40 in the second direction among the plurality of reinforcing portions 30 and 40.

The portions of the restraint plates 11 and 13 where the plurality of reinforcing portions 30 and 40 are provided have high rigidity, and are difficult to deform when an impact is input from the second direction. Therefore, by providing the stoppers at positions overlapping the corresponding reinforcing portions 30 and 40 in the first direction on both end sides in the second direction of the corresponding reinforcing portions 30 and 40 among the plurality of reinforcing portions 30 and 40, it is possible to suppress the stoppers 50 and 60 disposed between the power storage stack 20 and the pair of side wall portions 14 and 15 from directly pushing the power storage stack 20 when an impact is input from the second direction. Thus, damage to the power storage stack 20 can be suppressed.

### Embodiment 2

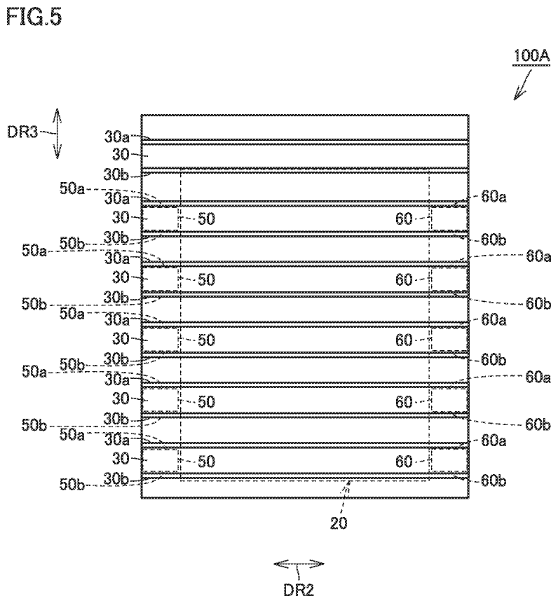

FIG. 5 is a plan view showing a positional relationship between an end portion of a reinforcing portion and an end portion of a stopper in the power storage device according to the second embodiment. With reference to FIG. 5, a power storage device 100A according to a second embodiment will be described.

As shown in FIG. 5, the power storage device 100A according to the second embodiment differs from the power storage device 100 according to the first embodiment in the positions of both ends 50a and 50b of the stopper 50 in the third direction and the positions of both ends 60a and 60b of the stopper 60 in the third direction. The other configurations are substantially the same.

When viewed from the first direction, the positions of both ends 50a and 50b of the stopper 50 in the third direction and the positions of both ends 60a and 60b of the stopper 60 in the third direction are positioned more inward than both ends 30a and 30b of the corresponding reinforcing portion 30 in the third direction. Although not shown in FIG. 5, similarly, the positions of both ends 50a and 50b of the stopper 50 in the third direction and the positions of both ends 60a and 60b of the stopper 60 in the third direction are positioned inside of both ends of the corresponding reinforcing portion 40 in the third direction.

Even in the case of such a configuration, the power storage device 100A according to the second embodiment can obtain substantially the same effect as the power storage device 100 according to the first embodiment. In addition, since the positions of both ends 50a and 50b of the stopper 50 in the third direction and both ends 60a and 60b of the stopper 60 in the third direction are positioned more inward than both ends of the corresponding reinforcing portions 30 and 40 in the third direction, it is possible to further suppress the stoppers 50 and 60 from being pushed inward by the side wall portions 14 and 15 when an impact is input from the second direction. Thus, the stoppers 50 and 60 arranged between the power storage stack 20 and the side wall portions 14 and 15 can further prevent the power storage stack 20 from being pressed directly.

### Embodiment 3

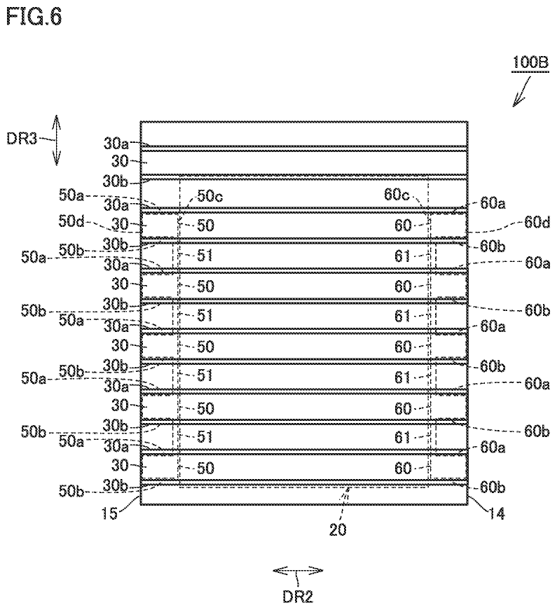

FIG. 6 is a plan view showing a positional relationship between a reinforcing portion and a stopper in the power storage device according to the third embodiment. With reference to FIG. 6, a power storage device 100B according to a third embodiment will be described.

As shown in FIG. 6, the power storage device 100B according to the third embodiment is different from the power storage device 100A according to the second embodiment in that a plurality of stoppers 50 are connected by a connecting portion 51 and a plurality of stockers 60 are connected by a connecting portion 61. The other configurations are substantially the same.

The connecting portion 51 connects the stoppers 50 adjacent to each other in the third direction. The connecting portion 51 is located closer to the inner surface 50c than the outer surface 50d of the stopper 50 in the second direction. Thereby, a gap is formed between the connecting portion 51 and the side wall portion 15.

The connecting portion 61 connects the stoppers 60 adjacent to each other in the third direction. The connecting portion 61 is located closer to the inner surface 60c than the outer surface 60d of the stopper 60 in the second direction. Thereby, a gap is formed between the connecting portion 61 and the side wall portion 14.

Even when the power storage device 100B is configured as described above, the power storage device 100B according to the third embodiment can obtain substantially the same effect as the power storage device 100A according to the second embodiment.

Further, by connecting the plurality of stoppers 50 and 60 by the connecting portions 51 and 61, alignment of the plurality of stoppers 50 and 60 can be easily performed.

Further, since the gap is formed between the connecting portion 51 and the side wall portion 15 and between the connecting portion 61 and the side wall portion 14 as described above, even when an impact is inputted from the second direction between the reinforcing portions adjacent to each other in the third direction, the connecting portions 51 and 61 can be prevented from being directly pressed by the side wall portions 15 and 14.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage device comprising:
a power storage stack including a plurality of power storage modules arranged in a first direction;
a pair of restraint plates that sandwich the power storage stack in between in the first direction;
a pair of side wall portions that are opposite to each other in a second direction orthogonal to the first direction, with the power storage stack located between the side wall portions; and
a plurality of stoppers located outside each of opposite sides of the power storage stack in the second direction and arranged between the power storage stack and each side wall portion of the pair of side wall portions, wherein
each restraint plate of the pair of restraint plates has an outer main surface located opposite to a side where the power storage stack is located,
on the outer main surface of each restraint plate of the pair of restraint plates, a plurality of reinforcing portions are disposed that each extend in the second direction and are arranged in a third direction orthogonal to the first direction and the second direction, and
each of the plurality of stoppers is disposed at a position overlapping, in the first direction, a corresponding reinforcing portion of the plurality of reinforcing portions, at each of opposite ends, in the second direction, of the corresponding reinforcing portion.

2. The power storage device according to claim 1, wherein
the power storage stack includes:
a cooler disposed between power storage modules adjacent to each other;
a first current collecting plate stacked on one side, in the first direction, of one endmost power storage module in the first direction; and
a second current collecting plate stacked on another side, in the first direction, of another endmost power storage module in the first direction, and
each of the plurality of stoppers is disposed in contact with the plurality of power storage modules and not in contact with the cooler, the first current collecting plate, and the second current collecting plate.

3. The power storage device according to claim 1, wherein
each of the plurality of stoppers has an inner surface facing the power storage stack, and
a heat insulating member is disposed on the inner surface.

4. The power storage device according to claim 1, wherein opposite ends, in the third direction, of each of the stoppers are located inside respective opposite ends, in the third direction, of the corresponding reinforcing portion, as seen in the first direction.

5. The power storage device according to claim 1, wherein each of the plurality of reinforcing portions includes:
a pair of flange portions that are disposed on the outer main surface, extend in the second direction, and are spaced from each other in the third direction;
a pair of standing wall portions that extend upright from respective inner ends, in the third direction, of the pair of flange portions; and
a connecting wall portion that connects the standing wall portions of the pair of standing wall portions.

6. The power storage device according to claim 5, wherein each of the plurality of stoppers is fastened to a corresponding reinforcing portion of the plurality of reinforcing portions.
